(19) United States
(12) Patent Application Publication
(10) Pub. No.: US 2003/0210275 A1
(43) Pub. Date: Nov. 13, 2003

(54) Extensible command-line description mechanism for activating external tools

(76) Inventors: Johann Draschwandtner, St. Georgen (AT); Jonathan Scott Headland, Salzburg (AT)

Correspondence Address: Fay Kaplun & Marcin, LLP, 7th Floor, Suite 702, 150 Broadway, New York, NY, 10038, US

(21) Appl. No.: 10/137,921

(22) Filed: May 2, 2002

(51) Int. Cl. G09G 5/00

(52) U.S. Cl. 345/810

(57) ABSTRACT

A graphical interface for displaying and editing command line instructions of an external software tool is described. The interface includes a GUI generation module having a data structure containing a list of command verbs of the external software tool and modifiers for the command verbs, and a GUI module for displaying the command verbs and modifiers as user selectable options in a graphical interface. Pre-existing command lines may also be displayed. The interface also includes a command line generation module for constructing a command line for the external software tool from the command verbs and modifiers selected in the graphical interface.

### BACKGROUND INFORMATION

Many software applications are controlled by a user through a command line interface (CLI) in which specific commands are issued on a command line, and are interpreted by the application to carry out various actions. Typically, different software applications use different commands that must be correctly used to control the application. Each command often includes one or more modifiers or options that modify how the instruction is to be carried out. These modifiers may be flags, strings, or other parameters, and may have a default value that is used if the developer does not specify a value.

One category of applications that typically are controlled using a CLI includes compilers, linkers, and data bases used when compiling source code into executable code. Various options may be selected when invoking one of these applications through the CLI, such as the input and output file names, the level of optimization, and the like. This approach gives the user great control over the operation of the application, but requires detailed knowledge of the commands and the syntax used by the application. If the commands are entered incorrectly, for example with erroneously listed options or with a syntax that is even slightly imprecise, the application is likely to not work, or to give unpredictable results.

In most cases, moreover, each software application uses a different set of commands and of optional command modifiers, which must be known and entered with the correct syntax by the user. A user that is proficient in utilizing one compiler thus has to be re-trained to successfully use a compiler from a different manufacturer. Even when only one application is used, care must be taken to enter exactly the same command line in successive uses of the application, to obtain consistent results. Existing conventional methods may be used to facilitate issuing command line instructions to different applications. In a first method, a set of textual fields is provided whereby a user can enter commands and options for those commands, and build up a command line based on the developer's knowledge of the application, or from information found in reference manuals. In another method, the application may include a hard-coded graphical user interface (GUI) used for setting options for the commands of that specific application.

The approaches described above only partially address some of the problems encountered in constructing commands to CLI based applications, and do not provide a general approach to controlling different applications without having to learn the specific details of each application.

### SUMMARY

The present invention is directed to a graphical interface to construct CLI command lines, which includes a graphical display module to represent elements of the command line with graphical display elements, an interface module to provide the graphical display module with descriptions of the elements represented graphically, and a command line generation module to incorporate the elements into the command line.

### BRIEF DESCRIPTION OF THE DRAWINGS

FIG. 1 is diagram showing elements of one embodiment of the command line interface according to the present invention;

FIG. 2 is a screen display showing another exemplary GUI generated according to another embodiment of the present invention; and

FIG. 3 is a flow chart showing the operating steps of an embodiment of the command line interface according to the present invention.

### DETAILED DESCRIPTION

The present invention can be further understood with reference to the following description of preferred exemplary embodiments and the related appended drawings, wherein like elements are provided with the same reference numerals. Embodiments according to the present invention will be described with reference to external software tools that include compilers and linkers. However, one skilled in the art will understand that the present invention may be used to control other types of software tools that operate using CLI commands.

Embodiments according to the present invention may be used to describe the commands for any software tool that is activated through a command line, such that an integrated software development environment can dynamically construct a graphical user interface (GUI) which is highly specific to that software tool. The GUI supports a user in competently modifying the operation of that software tool, without having to consult manuals or other external references. Embodiments according to the invention also permit the creation of new, more specific descriptions of commands that are derived from the existing, more generic descriptions. A family of related GUI's tailored to specific uses of the software tool may thus be generated from the generic command descriptions, with minimal additional effort on the part of the developer. For example, in the case of an external compiler tool, a specific command description for a Windows® optimized compiler may be created from the generic compiler command description.

The present invention assists the developer by facilitating the integration of external command line activated tools. In the following text, these are interchangeably referred to as CLI applications or external software tools. The developer is able to issue commands and set options to control the software tool without the need to consult written materials describing the tool, and without having to spend time becoming familiar with the tool's command line. The GUI according to the present invention describes the commands of the CLI application in a graphical way, and may assist the developer in several additional ways. For example, the GUI may permit the generation of only syntactically valid command lines, since the command lines are generated automatically from the developer's inputs. The GUI may disallow the use of mutually inconsistent or exclusive options, for example by not offering for selection certain options that are inconsistent with already selected options. Thus, only mutually non-exclusive options may be displayed for selection. Descriptive text may also be provided by the GUI, so that the developer is able to better understand the usage of various options and commands.

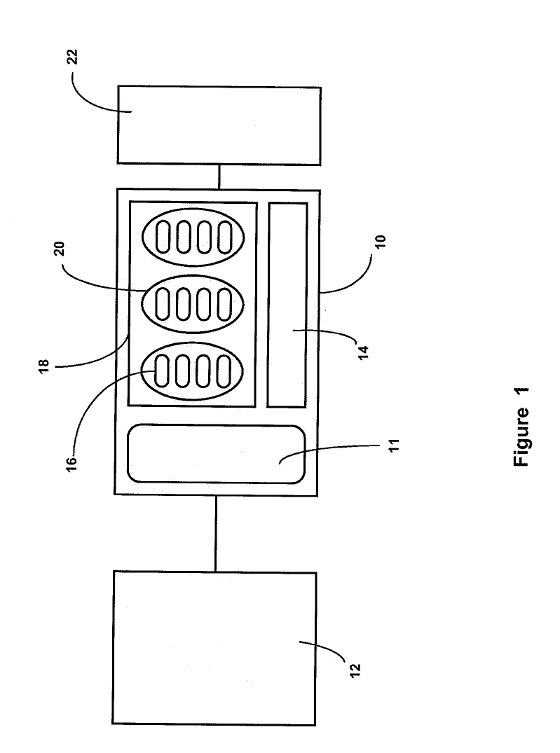

FIG. 1 shows an exemplary embodiment of a command line interface according to the present invention. A command line description mechanism, or command line interface module 10 may be used to facilitate generation of commands to an external software tool, such as CLI application 12. As indicated above, CLI application 12 may be any external software tool that is operated using command line instructions. In particular, the interface according to the present invention is well suited to graphically describe and integrate into a program suite external compilers, linkers, and database libraries used in generating executable code from source code.

Various types of instructions used to control the operation of external software tools may be described by interface module 10. The name of the executable command may form one part of the instruction, together with various switches and options that may be used to modify the operation of the executable command. Some of the more common options include:

toggle (or boolean) options, whose default state may be flipped or toggled by the presence of a specific flag in the command line. For example, the generation of debugging information may be turned on in some compilers by providing the proper flag in the command line, whereas the absence of the flag indicates that the default code generation, without debugging, should take place.

Alternative options may be specified, offering mutually exclusive alternatives to the compiler's behavior, by selecting one of a set of flags. For example, the degree of optimization to be performed by the compiler may be so selected, since it does not make sense to select more than one optimization level simultaneously.

Parameterized options may also be used, by specifying a string following a particular flag. For example, the filename used for a compiler's output may be specified in this manner.

The present invention provides a mechanism by which a graphical user interface (GUI) is generated that describes a command line. The GUI can be used by the developer to select commands and options to control the CLI application 12. As will be described below, a GUI display module 22 uses stored information that describes the commands used by CLI application 12 to generate a GUI, through which the commands and options may be selected. Interface module 10, and in particular command line generation module 11, then constructs a command line from the selections made by the developer, and provides it to the CLI application 12 for execution. For example, the display module 22, interface module 10 and command line generation module 11 may be suitable to be executed on a computer, such as a personal computer with a processor such as the Pentium® class processor manufactured by Intel Corp. of Santa Clara, Calif., and may operate in a Windows®, Unix or other environment. The data structures described below may be stored in devices adapted to store digital information, such as Random Access Memory (RAM), Dynamic Random Access Memory (DRAM), Read Only Memory (ROM), flash memory, a hard disk, an optical digital storage device, a combination thereof, etc.

In most cases, the command line of an external tool such as CLI application 12 consists of several parts. One such part is the executable-name, or the name of the executable program that is called to do the build. For example, this can be the Microsoft® compiler. As is usual in many modern compilers, multiple input languages may be used, such as C and C++. The compiled code can be generated for diverse target architectures, for example a specific operating system or computer. Another part of the command line may include essential-modifiers. These are options required to specialize the executable for the desired build tool, for example to make the compiler work as a C compiler rather than a compiler for another language.

In one exemplary embodiment according to the present invention shown in FIG. 1, the description mechanism or command line interface module 10 includes several sub-components. A first element is the command verb list 14, that includes command verbs corresponding to the names of executable programs that are part of the CLI application 12, and which may be started by the underlying operating system. These are the executable-names described above. For example, a command verb may invoke the generic Microsoft® compiler available in Windows® based systems by including the name “cl”. In addition to the name of the executable, command verbs in list 14 may also include “tightly bound” command line options, or essential-modifiers which modify the behavior of the executable program in some useful way. The “tightly bound” options are those options that would normally always be used in invoking the desired command in the specified environment, so that the developer would not seek to execute that command without the “tightly bound” options. For example, the option “-TC” can be used to instruct the Microsoft® compiler to use C as the input language. That option would thus always be used by a developer compiling C source code. In different embodiments, the command options may be left out of a more generalized command verb, which then would only include the name of the executable program.

A second element of the command line interface 10 is exemplified by the command line options 16, also shown schematically in FIG. 1. Command line options 16, unlike the “tightly bound” options of the command verb, are designed to be freely selected by the developer, since they represent options that may be set differently during execution of the CLI application 12 in the desired environment. For example, these command line options may include optional modifiers such as the “-Qifdiv” flag used to correct certain floating point division errors, and context-specific options like the name of the file to be compiled. In one exemplary embodiment, descriptions for groups of command line options 16 may be stored in a data structure 18, which may be associated with one or more specific command verbs of list 14. The data structure 18 may be stored in a file, which is specific to the software tool being controlled, for example the CLI application 12.

The data structure 18 may contain several groupings 20 of external-tool options, which further group command line options 16, and which serve to bring together under a common heading external-tool command line options 16 that have some conceptual relationship to one another. For example, in the case of options for the commands operating a compiler, all the options related to code optimization of the compiler may be included under one heading, within a single grouping 20 of external-tool options. The developer can access all the options related to a specific task by selecting the grouping 20 that addresses the task.

Data structure 18 may contain files to help the developer select appropriate command line options 16. For example, a textual description of the available options may be included, to give the developer the meaning and purpose of the options, without having to consult external sources. A description of the possible values of each option may be included, as well as a list of textual flags corresponding to the option, which may be passed to the external CLI application 12 if selected by the user. Additional information regarding the options available in each grouping 20 of external-tool options may be included in data structure 18, both to complete the mapping of selected options between the interface module 10 and the CLI application 12, and to provide background and context on the command options to the developer.

Using a data structure 18 and a list of command verbs 14 specific to an external tool enables the same interface module 10 to be used to describe the commands of different CLI applications. For example, if a different external tool CLI application is to be accessed, the only change that needs to be done to interface 10 is to provide a new data structure 18 with new lists of command verbs. The new data structure 18 may contain a listing of commands and available command options, a description of the commands and options, and any other information useful in generating a GUI for displaying the commands for the new CLI application. In this manner it is not necessary to have different interfaces adapted to different external tools. In fact, it may not even be necessary to recompile the interface module 10 and its components when a new external tool is used, since their operation does not change, and they simply use the new data structure as input.

In one exemplary embodiment according to the invention, the data structure 18 may be an internal data structure having one of two formats. The data structure may be a dictionary type structure or a list type array, wherein the list type array is generally used in a specified order, while dictionaries may be sorted in other manners, such as alphabetically. In one exemplary embodiment, the data file may be accessed with a call of the form:

struct (

“ToolSets” : struct (

“Diab-PowerPC” : struct (

“CCFLAGS” : “Diab Compiler Options”,
“CXXFLAGS” : “Diab Compiler Options” ),

“Microsoft-VisualC/C++” : struct (

“CCFLAGS” : “MSVC Compiler Options”,
“CXXFLAGS” : “MSVC Compiler Options”)),

In this embodiment, the field “ToolSets” represents the build tools and the corresponding options used when generating the GUI. In the example there are two GUI's available, one adapted for the Diab compiler and one for the Microsoft compiler. More specifically, with respect to the Microsoft compiler, if the user edits the CXXFLAGS of a build tool for a platform associated with the Microsoft toolset, the “MSVC Compiler Options” are used to create the GUI. The associated commands may have the form:

“MSVC Compiler Options” : struct (“Categories” : array (

“General”,
“Code Generation”,
“C++ Language”,
“Miscellaneous”))

In this case there are four tab pages that are created in the GUI dialog, representing the categories of the entry list. These are the “General”, “Code Generation”, “C++ Language” and “Miscellaneous” pages. The options in each of the tab pages may be specified as an array of dictionaries entries. Each of the dictionaries entries may include a Description and a Type. The “Type” may be one of the following:

| | |
|---|---|
| Group | (creates a Group box containing the specified Description) |
| Separator | (creates a small spacer, so the GUI layout becomes clearer) |
| Toggle | (creates a checkbox using the Description Slot) |
| Choice | (creates a combobox using the Description Slot) |

For “Toggle ” are “Choice” Types are additional “Entry Value” is found in the dictionaries, which specifies the command line option(s).

As indicated above, the “Entry Values” may be an array of dictionaries containing the values for the “Toggle” and “Choice” types. For the “Toggle” type, the array may have the form:

“Values” : array (struct (“CmdLineFlag” : “-Zi”))

The value in this example is only one dictionary with a slot for a “CmdLineFlag” string value. When the toggle is switched on, the string value is concatenated to the command line. For the “Choice” type, the array may have the form:

“Values” :array (struct( “DisplayFlag” : “Disabled”,“CmdLineFlag” : “”),

struct (“DisplayFlag” : “minimize space”,
“CmdLineFlag” : “-O1”),
struct (“DisplayFlag” : “maximize speed”,
“CmdLineFlag” : “-O2”))

In this case, the value contains multiple “structs”, each of which contains two slots. One slot is for “DisplayFlag”, which represents the value shown to the user in the GUI, and another slot is for “CmdLineFlag”, representing the corresponding command line value. For example, whenever a user selects the “minimize space” option from the droplist, the value “−01” is concatenated to the command line, and other incompatible flags are removed to avoid conflicts.

The command verb, including the executable name and the “tightly bound” options, can also be thought of as a specific build tool that operates the external software tool in a certain manner. For example, a build tool may control the external software tool to obtain a desired type of output. A platform identifies a set of specific build tools that can be used with an external software tool, and that are applicable to a target operating system (for example Solaris or Windows®), a type of family (for example GNU or Native) and possibly a “flavor” or set of preselected options for the build (such as Optimized or Debug). The platform conceptually groups together a consistent set of specific commands which can be used to build a particular variant of the software. In one exemplary embodiment, the output from building different platforms may be written to different subdirectories, thus reinforcing the idea that mixed outputs from different platforms are not normally used. In one embodiment, the platforms may be named according to a convention that describes some or all of the target machine architecture, operating system, family and other pre-selected options. For example, a platform named “Windows-GNU-Debug” may provide the value g++ for the command verb field of the C++ Compiler build tool.

Within a platform, the options that are set as part of the command verb are not modifiable. This is because these options specifically specialize the executable to create the desired build tool. Accordingly, in one exemplary embodiment of the present invention, the GUI generator module 22 and the interface module 10 recognize those flags that are present in a command line corresponding to those options, and suppress their presentation to the developer within the graphic interface. Since the developer is not allowed to modify the tightly-bound options within a platform, it is not necessary to present those options as part of the graphic interface. The options that are set as part of the command verb, however, may be modified using a standard options edit dialog, separate from the GUI generated by GUI generation module 22. They may also be modified by selecting another platform in which those options are modifiable.

However, one difficulty arises in cases where the command verb relies on the default behavior of the external tool, for example when a compiler requires no explicit flag to generate code that does not include debugging options, as opposed to other compilers that require such explicit flags. In that case, it is impossible to distinguish between omission of that flag and the implicit desire to use the default value of the build tool. This issue may be resolved by providing a distinct tool set for each build tool, even when two distinct build tools use the same command verb. For example, two platforms may be constructed, one called “Windows-Native” and another called “Windows-Nonoptimized”, both usable with the external build tool C Compiler. The first platform may use a command verb of the form “cl-c-TC”, and the interface may allow the developer to select a particular level of optimization. The second platform may use an identical command verb like (“cl-c-TC”), but the interface in this case does not allow the developer to select the optimization level, since that would conflict with the goal of the platform. The same approach may be used to handle other default flags of an external software tool.

The most generic possible tool set used in a CLI application is one where the command verb only includes the executable name of a build tool, with no options. For example, “cl”in the case of a compiler. This generic set includes all the tool sets that can be derived for specific build tools based on that executable name. From the generic set can easily be derived more specific tool sets, that can then be used to carry out more specialized operations of the CLI application. For example, some of the options may be hardcoded, such as setting the compile only option to true and the input language option to C in the Microsoft® compiler. The same may be done with levels of optimization, to develop platforms as described above. The operation of these generic and specific sets of tools may be transparent to the user, who after selecting the desired platform is presented with the appropriate graphical interface offering pertinent options, as will be described below.

According to embodiments of the present invention, interface module 10 and GUI generator module 22 dynamically generate a graphical user interface specific to the command verb being selected by the developer. The interface according to the invention also parses a given command line, interpreting its contents, in order to present that command line to the user in a graphical and descriptive way. This command line may be a pre-existing command line. A parsing module may be used to carry out the parsing functions, and the data structure 18 may be referenced to interpret the commands and options present in the pre-existing command line. Any default options that are assumed by the external tool are also correctly presented to the developer in a user friendly manner, as described above. The invention thus resolves the problem of presenting to the user commands and command variables in an easy to understand graphical format, using natural-language descriptions, while providing to the CLI application a corresponding command line having the correct syntax for that external tool.

In one exemplary embodiment shown in FIG. 1, a command line generation module 11 interprets the selections made by the developer through the GUI display module 22. Using the information in the data structures 18 of interface module 10, command line generation module 11 constructs the syntactically correct command line that is provided to CLI application 12. The syntax rules for different external software tools may be stored, for example, in corresponding data structures. Command line generation module 11 may be an integral part of interface module 10, or may be a separate software element that communicates with interface module 10. Similarly, GUI generation module 22 may be an integral part of interface module 10, or may be a separate unit.

As described above, the GUI generator module 22 does not change when different CLI applications 12 are selected. However, the details of what is shown by the GUI, specifically which command verbs and options are made available, depends on the CLI application and platform being selected. The selectable options for those command verbs that are part of the selected platform are provided to the GUI generator 22 by the data structure 18.

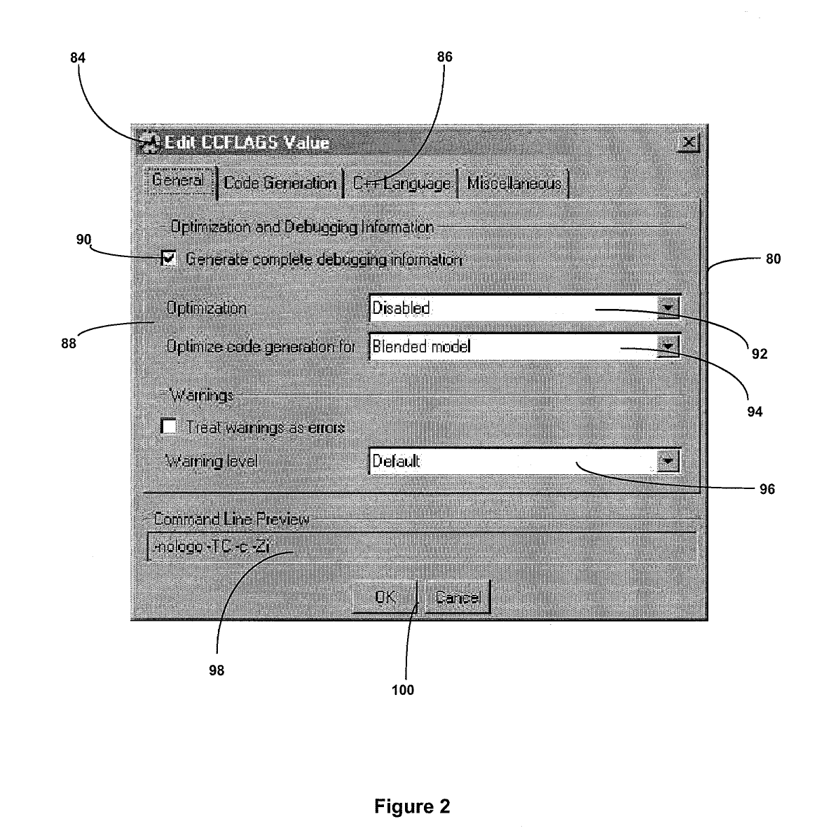

FIG. 2 shows an exemplary embodiment of a graphical description interface for a CLI command line. GUI 80 includes an action bar 84 identifying the options accessible from that page, and may also include additional header sections, such as a title bar. In one exemplary embodiment, several tabbed panes 86 may be selected, each containing various groups of related options and commands. The tabbed page format works well if few optional pages are selectable. However, if a larger number of pages is made available, a properties tree format or other different graphical regions may be more suitable. FIG. 2 shows a “general” page 88, where optimization and debugging information may be entered. Other selectable pages may be, for example, “code generation” pages, “C++” pages and “miscellaneous” pages. These additional pages are also generated based on information contained in data structure 18, and generally display graphically the various compiler options available within the selected platform and tool set.

General page 88 may include, for example, a check box 90 that gives to the developer the option of requesting generation of complete debugging information, and pull down menus 92 and 94 that allow respectively selection of the optimization level and the target of the optimization. Treatment of warnings may also be specified in fields 96, for example with a combination of check boxes and pull down menus. A command line preview field 98 may also be provided in GUI 80, to show to the developer the actual command line being generated by interface module 10. This feature is useful for more experienced developers, who may wish to see the command line before it is submitted to the CLI application 12. A set of buttons 100 may also be included in GUI 80 to execute or cancel the command line generation. Whenever the user selects an option, the command line generation module 11 builds the command line according to those options, and the command line may thus be displayed in preview field 98. It should be apparent that other types of user selectable graphic devices may be used in addition or instead of those described above.

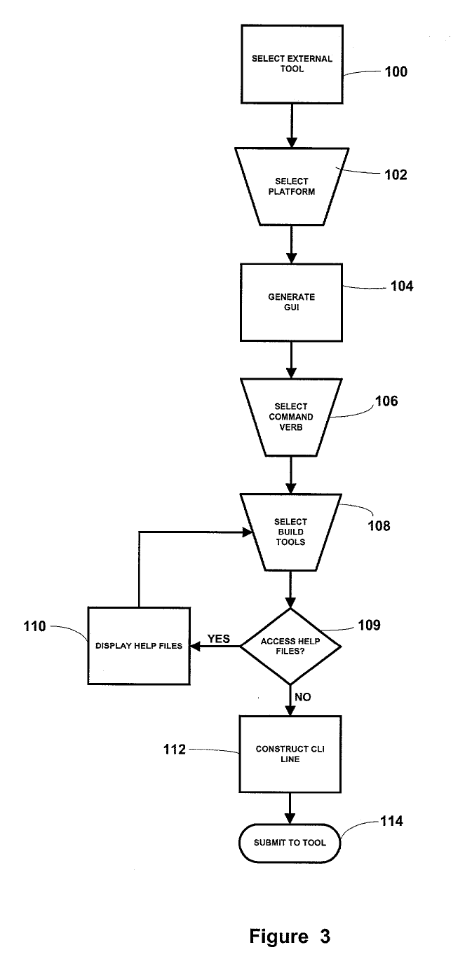

A description of exemplary steps to use the interface according to an embodiment of the present invention is presented with reference to FIG. 3. FIG. 3 shows a flowchart of the process for describing in a graphical command interface the commands for an external software tool such as CLI application 12. The flowchart also shows the process of using the inputs received from a developer through the interface to create a command line suitable for use in controlling CLI application 12. In a preliminary step 100, the user selects the external tool or application for which the command line is to be generated. This step may take the form of starting up a specific interface module, or selecting one of a plurality of interface modules already executing in a computer. For example, a file tree structure may be used to allow selection of the desired interface module, or to set up a generic interface module to work with the desired external tool. The developer may be presented with options to select the desired platform in step 102. As described above, the platform corresponds to the desired set of specific build tools that can be used with the selected external software tool, and that are applicable to a target operating system. This selection may be made through the graphical interface, or through other conventional methods.

The GUI for the desired platform is generated in step 104. Here, information from the command verb list 14 and the data structures 18 is used by GUI display module 22 to construct a display that may include pull down menus, check boxes, text boxes or any other graphical devices that present the platform's commands and options in an easy to understand format. For example, the GUI display module 22 may include sets of standardized visual representations for commands and options that are used in command lines of external applications. These may be standard Visual commands. HTML commands, or commands for another graphic display package. The layout of the visual representations that appears in the GUI may be stored as a default layout in GUI display module 22, or in a separate storage location. In addition to or instead of the default representations and layout, specific applications may use dedicated graphical representations. In this case, the information regarding the layout and appearance of the graphical representations may be stored in a data structure specific to that application.

In one exemplary embodiment, the GUI may resemble an interface used in Windows® operating systems, or may resemble a web page. The GUI may include several different screens or windows that are presented to the developer depending on the selections made. In steps 106, 108 the developer may select respectively command verbs, and options and variables associated with the command verbs, for example by checking the appropriate boxes, selecting options from pull down menus, or typing names of files. If the developer requires additional information about any of the options, step 109 may direct the process to access the help files in step 110, where the appropriate text files are displayed in the GUI. The help step 110 may be executed whenever the developer requires assistance with the selections.

Once all the selections have been made in the GUI, the command line used by the CLI application 12 is constructed in step 112. For example, command line generation module 11 may receive the information entered in the GUI, and may place the appropriate commands and flags in a command line, using the information about the construction line structure found in the list of command verbs and in the data structures of interface module 10. Alternatively, the command line may be constructed by command line generator 11 every time a new command verb or option is selected by the user, for example in steps 106-108. In this manner, the currently described command line is always available for viewing. Once the command line has been generated, it may be accepted (“OK” button) or canceled (“Cancel” button) by the user. If accepted, the newly constructed command line replaces any older command line, and is sent to the external software tool in step 114, where it may be executed. It should be noted that although the above procedure was described in the order shown in FIG. 3, various steps may be carried out in a different order, without affecting the result according to the present invention.

Although the invention was described with reference to an external software tool exemplified by a compiler and a linker, the invention is not limited to the exemplary embodiments described. The specification and drawings are thus to be regarded as being illustrative rather than restrictive. It will be apparent to those skilled in the art that various modifications and variations can be made in the structure and the methodology of the present invention, without departing from the spirit or scope of the invention. Thus, it is intended that the present invention cover the modifications and variations of this invention provided they come within the scope of the appended claims and their equivalents.

What is claimed is:

1. An interface for describing command line instructions of an external software tool, comprising:
a data structure containing a list of command verbs of the external software tool and modifiers for the command verbs;
a GUI module configured to display user selectable representations of the command verbs and modifiers in a graphical interface; and
a command line module configured to construct a command line for the external software tool from the command verbs and modifiers selected in the graphical interface.

2. The interface according to claim 1, wherein the data structure further comprises location information to place the modifiers in the command line.

3. The interface according to claim 1, wherein the GUI module is adapted to display the user selectable representations as at least one of check boxes, pull down menus, textual menus and textual fields.

4. The interface according to claim 1, wherein the GUI module is adapted to display related sets of user selectable representations in different graphical regions.

5. The interface according to claim 1, wherein information in the data structure is arranged in tool sets of related command verbs and modifiers, each of the tool sets including names and location information for the related command verbs and modifiers.

6. The interface according to claim 5, wherein the information in the data structure is further arranged in platforms of related tool sets, each of the platforms including tool sets adapted to operate on a selected operating system and architecture.

7. The interface according to claim 1, wherein the data structure is selectable among a plurality of data structures, each of the plurality of data structures containing information for a different external software tool.

8. The interface according to claim 1, wherein the GUI module is configured to prevent displaying representations of modifiers incompatible with already selected modifiers, based on information in the data structure.

9. The interface according to claim 2, wherein the command line module is adapted to construct the command line containing the selected command verbs and modifiers based on syntax given by the location information.

10. The interface according to claim 1, wherein the a command line module is configured to construct a generic command line for the external software tool from a pre-selected command verb.

11. The interface according to claim 10, wherein the command line module is configured to construct specific command lines from the generic command line from the pre-selected command verb and user-selected modifiers.

12. The interface according to claim 1, further comprising a parsing module to parse a pre-existing command line, the parsing module cooperating with the GUI module to display graphical representations of the pre-existing command line.

13. A method of editing a command line for an external software tool using a graphic interface, comprising:
generating a graphic display containing user selectable representations of command verbs and options of the external software tool;
placing user selected command verbs and options in a textual string, according to a required syntax of the external software tool; and
submitting the textual string to the external software tool for execution.

14. The method according to claim 13, further comprising displaying at least one of a pull down menu, check box and text box to represent the command verbs and options.

15. The method according to claim 13, further comprising determining mutually non-exclusive options of the user selectable options, and displaying the representations of the mutually non-exclusive options in the graphic display.

16. The method according to claim 13, further comprising displaying help files related to the user selectable command verbs and options.

17. The method according to claim 13, further comprising:
associating selected options with a selected command verb, to form a build tool adapted to generated desired output types from the external tool; and
displaying the build tool as a user selectable option in the graphic display.

18. The method according to claim 15, further comprising grouping a plurality of the build tools in a platform, the plurality of build tools being selected to obtain logically related output types from the external tool.

19. The method according to claim 17, further comprising preventing selection of user selectable options inconsistent with a selected build tool.

20. The method according to claim 13, further comprising placing the selected command verbs and options in the textual string at locations specified by rules stored in a data structure associated with the external software tool.

21. The method according to claim 20, further comprising conforming a syntax of the textual string with the syntax rules in the data structure.

22. The method according to claim 20, further comprising the preliminary step of selecting a data structure appropriate to the external software tool.

23. The method according to claim 13, further comprising displaying the textual string prior to the submitting step.

24. The method according to claim 13, further comprising generating graphic display of a user-selectable generic function containing a pre-selected command verb, and placing the user selected generic function in the textual string.

25. The method according to claim 24, further comprising generating specific functions by combining the user-selected generic function with user-selected options, and placing the specific functions in the textual string.

26. The method according to claim 13, further comprising the preliminary steps of obtaining a pre-existing command line, and generating the graphic display containing user selectable representations of command verbs and options of the pre-existing command line.

27. The method according to claim 26, further comprising determining the command verbs and options of the pre-existing command line by referencing rules stored in a data structure associated with the external software tool.

28. A graphical user interface to display a command line of an external tool, comprising:
user selectable graphic devices corresponding to command verbs of the external tool;
user selectable graphic devices corresponding to options of selected ones of the command verbs; and
execution commands to construct the command line according to selected ones of the command verbs and the options.

29. The graphical user interface according to claim 28, further comprising user selectable pages corresponding to sets of logically related command verbs.

30. The graphical user interface according to claim 28, further comprising a data structure containing syntax information of the external tool to place the selected ones of the command verbs and options in the command line.

31. The graphical user interface according to claim 28, further comprising user requestable help windows describing the command verbs and options.

32. The graphical user interface according to claim 28, further comprising user selectable representations of generic functions, the generic functions corresponding to pre-selected command verbs.
